(19) United States
(12) Patent Application Publication
(10) Pub. No.: US 2012/0245927 A1
(43) Pub. Date: Sep. 27, 2012

(54) SYSTEM AND METHOD FOR MONAURAL AUDIO PROCESSING BASED PRESERVING SPEECH INFORMATION

(75) Inventor: Jeffrey Paul BONDY, Waterloo (CA)

(73) Assignee: ON SEMICONDUCTOR TRADING LTD., Hamilton HM 19 (BM)

(21) Appl. No.: 13/425,138

(22) Filed: Mar. 20, 2012

Related U.S. Application Data
(60) Provisional application No. 61/454,642, filed on Mar. 21, 2011.

(51) Int. Cl. G10L 21/02

(52) U.S. Cl. 704/203; 704/E21.004

(57) ABSTRACT

A method, system and machine readable medium for noise reduction is provided. The method includes: (1) receiving a noise corrupted signal; (2) transforming the noise corrupted signal to a time-frequency domain representation; (3) determining probabilistic bases for operation, the probabilistic bases being priors in a multitude of frequency bands calculated online; (4) adapting longer term internal states of the method; (5) calculating present distributions that fit data; (6) generating non-linear filters that minimize entropy of speech and maximize entropy of noise, thereby reducing the impact of noise while enhancing speech; (7) applying the filters to create a primary output in a frequency domain; and (8) transforming the primary output to the time domain and outputting a noise suppressed signal.

### FIELD OF INVENTION

The present invention relates to signal processing, more specifically to noise reduction based on preserving speech information.

### BACKGROUND OF THE INVENTION

Audio devices (e.g. cell phones, hearing aids) and personal computing devices with audio functionality (e.g. netbooks, pad computers, personal digital assistants (PDAs)) are currently used in a wide range of environments. In some cases, a user needs to use such a device in an environment where the acoustic characteristics include some undesired signals, typically referred to as “noise”.

Currently, there are many methods for audio noise reduction. However, the conventional methods provide insufficient reduction or unsatisfactory resulting signal quality. Even more so, the end applications are portable communication devices and are power constrained, size constrained and latency constrained.

US2009/0012783 teaches altering the power estimates of the Wiener filter to speech and noise models and instead of utilizing mean square error, taking into account the speech distortion that takes into account psychophysical masking. US2009/0012783 deals with the degenerate case of the Wiener filter known as spectral subtraction, and generates a gain mask.

US2007/0154031 is for stereo enhancement with multiple microphones, which uses signals in a manner to create a speech and noise estimate, as a possible improvement to the standard Wiener filter. In exemplary embodiments, energy estimates of acoustic signals received by a primary microphone and a secondary microphone are determined in order to calculate an inter-microphone level difference (ILD). This ILD in combination with a noise estimate based only on a primary microphone acoustic signal allow a filter estimate to be derived. In some embodiments, the derived filter estimate may be smoothed. The filter estimate is then applied to the acoustic signal from the primary microphone to generate a speech estimate.

US20090074311 teaches visual data processing including tracking and flow to deal with interfering or obscuring noises in a visual domain. The visual domain has opacity and therefore can use some heuristics to “connect” an object. It shows that sensory information can be enhanced through the use of connecting flow.

U.S. Pat. No. 7,016,507 teaches detection of the presence or absence of speech, which calculates an attenuation function.

Despite the forgoing different approaches to noise reduction/signal enhancement, there is a still growing need in portable devices for improved speech quality. Therefore, it is desirable to provide a method and system that implements new noise reduction technique and can be applied to portable devices.

### SUMMARY OF THE INVENTION

It is an object of the invention to provide an improved system and method that alleviates problems associated with the existed systems and methods for portable communication devices.

According to an aspect of the present disclosure, there is provided a method which includes: (1) receiving a noise corrupted signal; (2) transforming the noise corrupted signal to a time-frequency domain representation; (3) determining probabilistic bases for operation, the probabilistic bases being priors in a multitude of frequency bands calculated online; (4) adapting longer term internal states to calculate posterior distributions; (5) calculating present distributions that fit data; (6) generating nonlinear filters that minimize entropy of speech and maximize entropy of noise, thereby reducing the impact of noise while enhancing speech; (7) applying the filters to create a primary output in a frequency domain; and (8) transforming the primary output to the time domain and outputting a noise suppressed signal.

According to another aspect of the present disclosure, there is provided a machine readable medium having embodied thereon a program, the program providing instructions for execution in a computer for a method for noise reduction. The method includes: receiving acoustic signals; determining probabilistic bases for operation, the probabilistic bases being priors across multiple frequency bands calculated online; generating nonlinear filters that work in an information theoretic sense to reduce noise and enhance speech; applying the filters to create a primary acoustic output; and outputting a noise suppressed signal.

### BRIEF DESCRIPTION OF THE DRAWINGS

These and other features of the invention will become more apparent from the following description in which reference is made to the appended drawings wherein:

FIG. 1 illustrates an example of an audio signal processing module having noise reduction mechanism on audio signals in accordance with an embodiment of the present disclosure;

FIG. 2 illustrates an example of a WOLA configuration by which the audio signal processing module of FIG. 1 is implemented;

FIG. 3 illustrates an example of an iteration implemented in posterior distribution calculation in the module of FIG. 1;

FIG. 4 illustrates an example of a posterior built in current block posterior distributions calculation in the module of FIG. 1;

FIG. 5 illustrates an example of a ζ function;

FIG. 6 illustrates an example of a decision module with Voicing Activity Detector (VAD) that may be incorporated with the audio signal processing module of FIG. 1;

FIG. 7 illustrates a graph for a standard deviation. (taken from http://en.wikipedia.org/wiki/Normal_distribution;

FIG. 8 illustrates shapes of curves for different β parameters;

FIG. 9 illustrates an example of an improved ζ function; and

FIG. 10 illustrates example of unscented transformation (UT) for mean and covariance propagation; a) actual, b) first-order linearization (EKF), c) UT (taken from http://www.cslu.ogi.edu/nsel/ukf/node6.html (Eric Wan's introductory page).

### DETAILED DESCRIPTION

One or more currently preferred embodiments have been described by way of example. It will be apparent to persons skilled in the art that a number of variations and modifications can be made without departing from the scope of the invention as defined in the claims.

On type of audio noise reduction is achieved by using Wiener filters. This type of systems will calculate the power in the signal (S) and noise (N) of an audio input and then (if the implementation is in the frequency domain), apply a multiplier of S/(S+N). As S becomes relatively large the frequency band goes to a value of one, while if the noise power in a band is large the multiplier goes to zero. Hence the relative ratio of signal to noise dictates the noise reduction. The typical extensions include having a slowly varying estimator of S or N, using various methods such as a voicing activity detector to improve the quality of estimates for S and N, changing S or N from power estimators to models, like speech distortion or noise aversion, allowing those models to mimic non-stationary sources, especially noise sources. Another large addition to the standard filtering approach is to include the type of psychophysical masking made popular by MPEG3 or similar coding into the speech distortion metric.

The other major type of noise reduction in audio systems is the use of sensor (e.g. microphone) arrays. By combining signals from two or more sensors spatial noise reduction can be realized, resulting in an improved output SNR. For instance if a signal arrives at both sensors of a two sensor array at the same time, while there is a diffuse noise field which arrives at the sensors at random times then simply adding the sensor signals together will double the signal, but sometimes the diffuse field will add up constructively, sometimes destructively, on average resulting in a 3 dB SNR improvement. The basic improvements to the summing beamformer are filter and sum or delay and sum which allows for different frequency responses and improved targeting. This targeting means either a beam can be steered at a source, or a null can be steered towards a noise source, a null being generated when the two sensor signals are subtracted. Some intelligence can be added to the null steering by calculating direction of arrival. Advanced techniques start with the Frost beamformer, extend to the Minimum Variance Distortionless Response (MVDR) beamformer and are both degenerate cases of the Generalized Side Lobe Canceller (GSC).

By contrast, in a non-limiting example, a system and method according to an embodiment of the present disclosure processes time samples into blocks for a frequency analysis, for example, with a weighted, overlap and add (WOLA) filterbank for transforming a time domain signal into a time-frequency domain. The system and method according to the embodiment of the present disclosure takes the frequency data and drives a decision device that takes into account the past states of processing and produces a probability of speech and noise. This feeds into a nonlinear function that maximizes as the probability of speech dominates the probability of noise. The nonlinear function is driven by probability function for the speech and noise. Since nonlinearities may be disturbing to a listener the nonlinear processing applied is designed to limit audible distortions.

Audio signals do not block other audio signals and they are not opaque. Audio signals combine linearly and thus need a framework that is not absolute and can deal with each block having some signal and noise. Instead of hard decisions audio flow may be used to build probabilities that a point in time-frequency is speech or noise and denoise sensory information. The audio ecology may be translucent. Thus instead of building magnitude spectral estimates the system and method according to the embodiment of the present disclosure builds probability models to drive a nonlinear function in place of the attenuation function.

In another non-limiting example, probabilistic bases for operation may be replaced with heuristics to reduce computational load. Here distributions are replaced with tracking statistics, minimally identifying mean, variance and at least another statistic identifying higher order shape. For example, Bayes optimal adaptation of posteriors may be replaced. The nonlinear decision device may be replaced with a heuristically driven device, the simplest example being a binary mask; unity gain when the probability that the input is speech is greater than the probability that the input is noise; otherwise attenuate. In general the probabilistic framework is expounded upon in each subsection and one or more proxy heuristics are given following it.

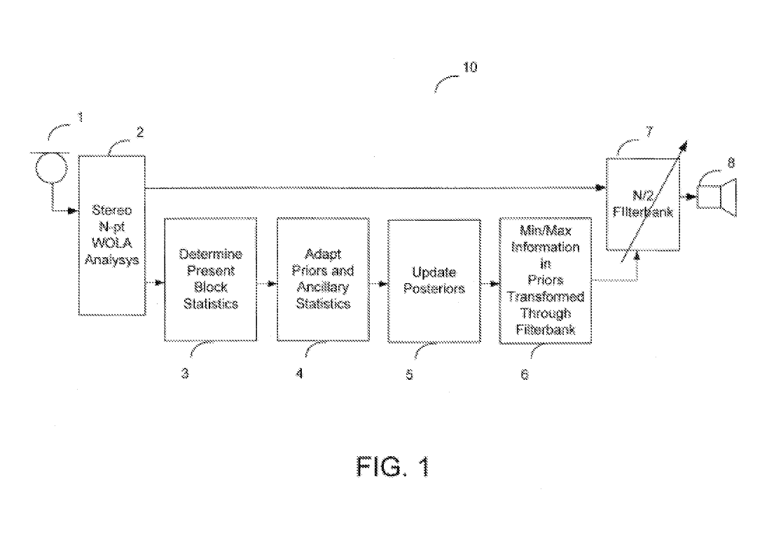

Referring to FIG. 1, there is illustrated an example of a signal processing module 10 having noise reduction mechanism. The module 10 includes monaural audio processing based on preserving speech information. The processing uses flows of speech and noise to de-noise input frequency analyses. With audio all the objects add to one another, and thus use, for example, the probabilistic framework to disambiguate. The module 10 calculates a non-linear kernel, rather than gain masks or attenuation functions. The non-linear kernel is a parameterized function whose shape is a function of input statistics over time. A simple example would be a sigmoidal gain whose steepness increases with increasing probability of speech over probability of noise. Another example could be a function or mixture of functions dependent upon which part of speech is active, thus with in unvoiced speech it may switch to resemble a Chi-Squared envelope to enhance the temporal information.

The module 10 in FIG. 1 may be implemented by any hardware, software or a combination thereof. The software code, instructions and/or statements, either in its entirely or a part thereof may be stored in a computer readable memory. Further, a computer data signal representing the software code, instructions and/or statements, which may be embedded in a carrier waver may be transmitted via communication network. Noise reduction is achieved in the module 10 by the following steps/modules.

In step 1 (microphone module 1) of FIG. 1, input time domain signals are blocked into a buffer. The input time domain signal is typically a noise corrupted signal.

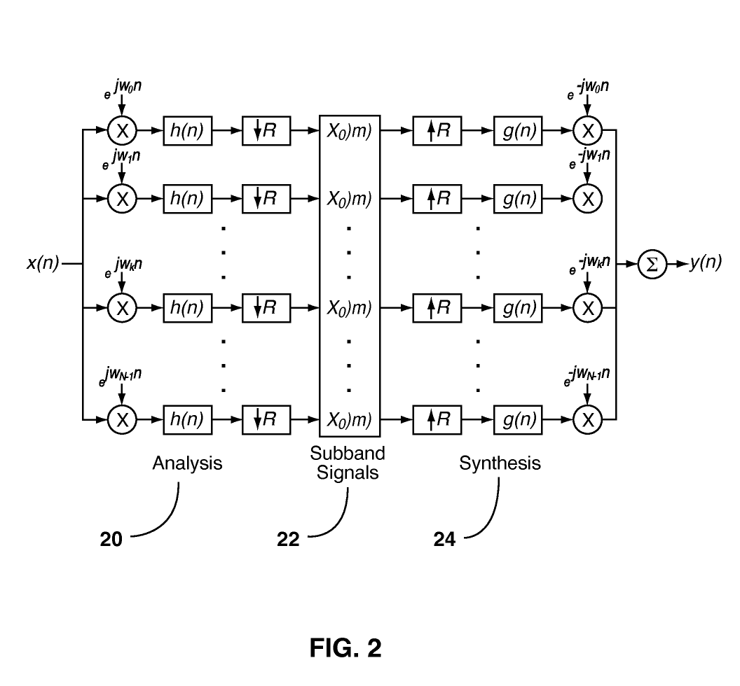

In step 2 (transformer 2 or analysis module 2) of FIG. 1, frequency analysis is implemented. Each block data is analyzed by, for example, but not limited to, an oversampled filterbank based on a weighted-overlap-add (WOLA) on blocks of sampled-in-time data from multiple channels (e.g., N-point WOLA analysis filterbank 20 of FIG. 2). The input is described in Equation (1) and the output is described in Equation (2).

In step 3 (statistical determination module 3) of FIG. 1, the probabilities of speech and noise are determined. The probabilistic bases are priors in a multitude of frequency bands and calculated online. This input follows from the previous block 2 and the output is the essential variables for calculating the distributions in steps 4, 5, and 6. The minimum statistics are magnitude and phase per frequency band. These could possibly be expanded to their first derivative, or generalized to any derivative or moment.

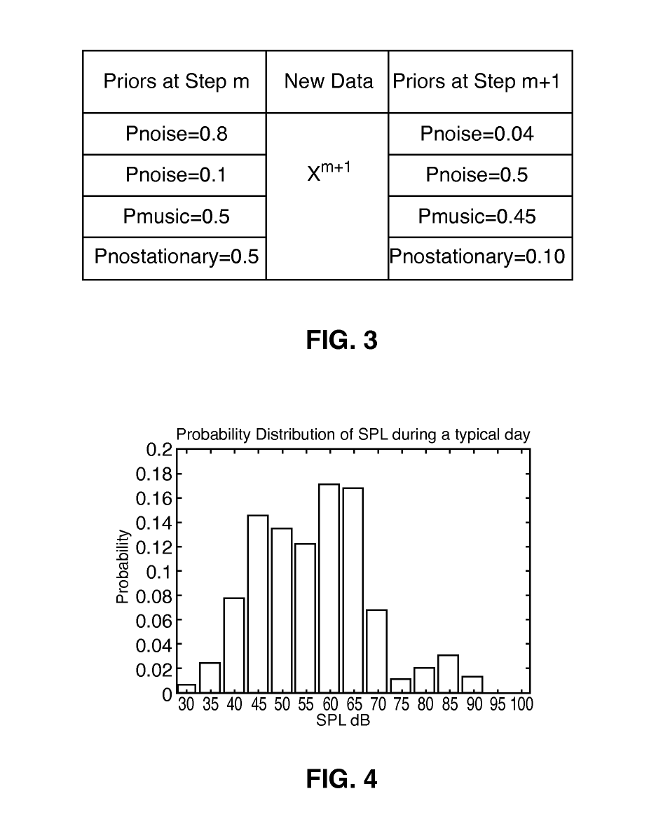

In step 4 (posterior distributions calculator 4) of FIG. 1, long term posterior distributions are calculated from the steps 2 and 3. Priors and ancillary statistics are adapted to update the shape of the speech and noise posteriors. The input follows from the previous block and the output is described in Equation (4) and Equation (5). These are the minimum necessary priors for a realistic embodiment, other probability distributions could include the probability of voiced speech, unvoiced speech, various non-stationary noise types or music. An example iteration is shown in FIG. 3.

In step 5 (current block posterior distributions calculator 5) of FIG. 1, current block posterior distributions are calculated from present and short term data compared to the long term distributions. The input follows from the previous block 4 as well as the frequency analysis. The minimum output is described in Equation (6) and Equation (7). The straightforward implementation would be a probability mass function described by a histogram of the magnitudes by frequency binned every dB. It would be appreciated that other posteriors may be phase consistency over time and the rate of change in time or frequency or a correlation of both. An example posterior built with binning pressure levels every 5 dB is shown in FIG. 4.

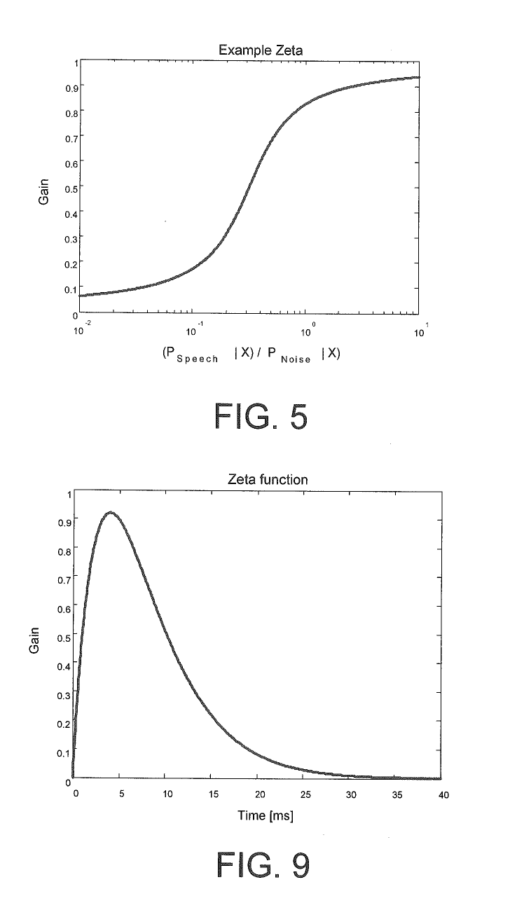

In step 6 (gain calculator 6) of FIG. 1, gains for each frequency band are calculated. The input follows from the previous blocks 5 that computed probabilities. This step 6 follows Bayes rule to calculate the frequency analysis that is most probable for minimally speech and noise, but again can be extended as in step 4. These drive the gain function in Equation (13). The simplest gain function is a binary mask. When P_{Speech}>>P_{Noise}ζ=1; otherwise ζ=0. FIG. 5 indicates a typical ζ function. Additionally with X^{t}m calculated for each class one can denoise the estimate directly. For certain sounds phase difference block to block are highly deterministic, thus phase and gain smoothing can take place.

In step 7 (gain adjustment module 7) of FIG. 1, the gains are applied to the present block of data, or some short term previous block.

In step 8 (transformer 8 or convertor 8) of FIG. 1, a time domain output is generated. This may be achieved, for example, with a WOLA synthesis filterbank (e.g., 24 of FIG. 2).

In a non-limiting example, the module 10 generates, in step 6, nonlinear filters that minimize entropy of speech and maximize entropy of noise thus reducing the impact of noise while enhancing speech. The filters are applied, in step 7, to create a primary output. This primary output is transformed to the time domain in step 8, and a noise suppression signal is output. The nonlinear filters of step 6 may be derived from higher order statistics. In step 5, the adaptation of longer term internal states may be derived from an optimal Bayesian framework. Soft decision probabilities may be limited or a hard decision heuristic is used to determine the nonlinear processing based on a proxy of information theory. The probabilistic bases in steps 3, 4 and 5 may be formed by point sampling probability mass functions, or a histogram building function, or the mean, variance, and a higher order descriptive statistic to fit to the generalized Gaussian family of curves). Step 6 may have an optimization function using a proxy of higher order statistics, or a heuristics, or calculation of kurtosis or fitting to the generalized Gaussian and tracking the (3 parameter.

It will be appreciated by one of ordinary skill in that art that the module 10 is schematically illustrated in FIG. 1. The module 10 may include components not shown in the drawings. Priori knowledge of noise reduction statistics may be embedded in the module 10. Priori knowledge of speech enhancement statistics may be embedded in the module 10. Psychoacoustic masking in the generation of filters may be implemented in the module 10. Spatial filtering before the noise reduction operation may be implemented with the module 10.

Referring to FIG. 2, there is illustrated an example of a WOLA filterbank on which the module 10 is implemented. The WOLA filterbank system uses a window and fold technique for the analysis filtering 20, a subband processing 22 having an FFT for modulation and demodulation, and an overlap-add technique for the synthesis filtering 24. The step 1 of FIG. 1 is implemented at the analysis filterbank 20, the steps 2-7 of FIG. 1 are implemented at the subband processing module 22, and the step 8 of FIG. 1 is implemented at the synthesis filterbank 24.

Referring to FIGS. 1 and 2, the operation and process in each step (module) is described in detail below.

In step 1, an acoustic signal is captured by a microphone and digitized by an analog to digital converter (not shown), where each sample is buffered into blocks of sequential data. In step 2, each block of data is converted into the time-frequency domain. In a non-limiting example, the time to frequency domain conversion is implemented by the WOLA analysis function 20. The WOLA filterbank implementation is efficient in terms of computational and memory resources thereby making the module 10 useful in low-power, portable audio devices. However, any frequency domain transform may be applicable, which may include, but not limited to Short-Time-Fourier-Transforms (STFT), cochlear transforms, subband filterbanks, and/or wavelets (wavelet transformers).

For each block the transformation is shown below. Those skilled in art will recognize that this example of frequency domain transformation for complex numbers can be extended and applied to the real case.

$$\{ {x}_{0} , {x}_{1} , … , {x}_{N} \} {->}^{F} \{ {X}_{0} , {X}_{1} , … , {X}_{\frac{N}{2}} \} \qquad ( 1 )$$

where xi represents i channel data in time domain and Xi presents i frequency band (subband) data.

The m^{th} block is succinctly as:

$$\begin{matrix}\{ {x}_{0} , {x}_{1} , … , {x}_{N} \} = {x}^{m} & ( 2 ) \\ \{ {X}_{0} , {X}_{1} , … , {X}_{\frac{N}{2}} \} = {X}^{m} & ( 3 )\end{matrix}$$

The present block of frequency domain data has the probability of speech and noise calculated in step 3. In a non-limiting example, the updating of speech and noise priors in step 3 are controlled through, for example, but not limited to, a soft decision probability of fitting the previously calculated posteriors function. It would be appreciated by one of ordinary skill in the art that any decision device can be used including Voicing Activity Detectors (VAD), classification heuristics, HMMs, or others. The embodiment uses nonlinear processing based on information theory that makes use of the temporal characteristics of speech.

P_{speech}[m+1]=f₁(P_{speech}[m],X^{m+1}) (4)

Pₙₒᵢₛₑ[m+1]=g₁(Pₙₒᵢₛₑ[m],X^{m+1}) (5)

where P is the prior distribution based on the log magnitudes of the frequency domain data. Pspeech and Pnoise represent probabilities on how prevalent either speech or noise is. In their most accessible form they are numbers and their sum could add up to 1. Both the functions f₁ and g₁ are update functions that quantify the new data's relationship to the previous data and update the overall probabilities. This decision device drives the adaption in step 4. The optimal update will use a Bayesian approach, a short cut of which can normalize to have Pᵢ[m+1]=(P[m]P(i|X^{m})/ΣPⱼ. This may be a computationally inefficient process. A well known substitute has a Voice Activity Detection (VAD), such as AMR-2 (see FIG. 2) to be used for f₁ and g₁.

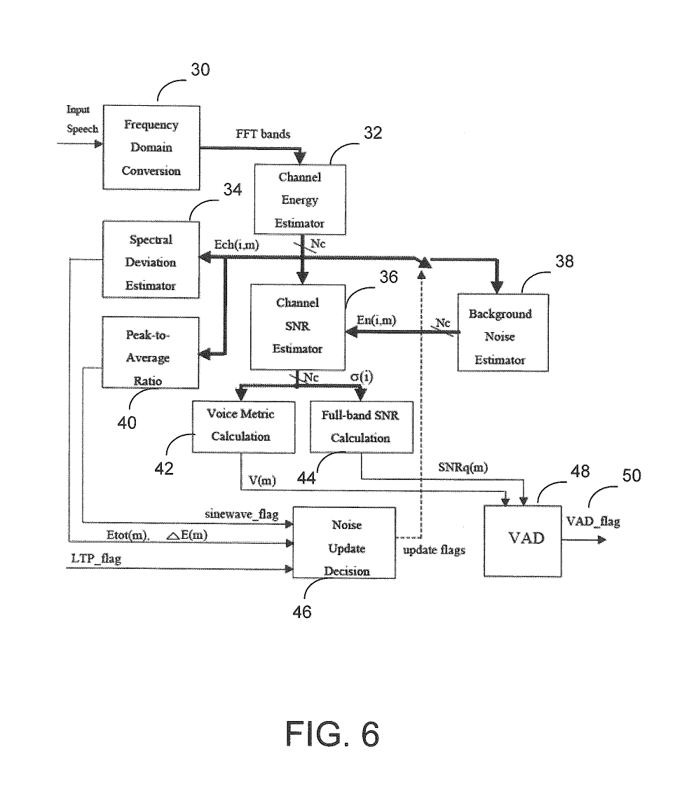

One example of the decision device is illustrated in FIG. 2, which is disclosed in ETSI AMR-2 VAD: EVALUATION AND ULTRA LOW RESOURCE IMPLEMENTATION, E. Cornu, H. Sheikhzadeh, R. L. Brennan, H. R. Abutalebi, E. C. Y. Tam, P. Iles, and K. W. Wong, 2003 International Conference on Acoustics Speech and Signal Processing (ICASSP'03). In FIG. 6, the system converts input speech into FFT band signals 30, and then estimates channel energy 32, spectral deviation 34, channel SNR 36, and background noise 38. The system implements noise update decision 46, by using peak-to-average ratio 40 and the estimated special deviation. The system further implements voice metric calculation 42 and full-band SNR calculation 44. The system then implements VAD 48. VAD_flag 50 output from the VAD 48 is a hard decision, updating P_{speech} when it detects speech and Pₙₒᵢₛₑ when it does not.

Another implementation replaces the VAD_flag with some sort of classification step such as a HMM or heuristics. Multiple HMMs can be trained to output the log probabilities of how the input X^{m}, matches speech and noise, or many different kinds of noise. The log probabilities can give a soft decision to update the priors, or a simpler implementation can pick the most likely classification much like the VAD_flag. The standard training of an HMM maximizes the mutual information between the training set and the output. A better alternative minimizes the mutual information between the speech classification HMM and the one or more noise classification HMMs, and vice-versa. This ensures maximal separability in the classifier as opposed to maximal correctness which has been seen to be beneficial in practice. Any other set of heuristics can be used. In general one is looking for a feature space that has maximal separability of speech versus the class of noise.

One heuristic that shows adequate separability is tracking amplitude modulated (AM) envelopes. Drullman, R., Festen, J., & Plomp, R. (1994). “Effect of reducing slow temporal modulations on speech reception”. J. Acoust. Soc. Am., 95 (5), 2670-2680 highlights how important low frequency Amplitude modulations are to speech. This has been well known in dating back to Houtgast, T. & Steeneken, H. (1973): “The modulation transfer function in room acoustics as a predictor of speech intelligibility”. Acustica, 28, 66-73. The well known Speech Transmission Index stems from Steeneken, H. & Houtgast, T. (1980). “A physical method for measuring speech-transmission quality”. J. Acoust. Soc. Am., 67, 318-326, so tracking the low AM rates gives a good approximation of what is intelligible, and therefore what should be speech. Tracking slow AMs is a low processing but relatively high memory task and has been shown to be effective in the real world. Using this tracking to aid in the separation of speech from noise is introduced in the module 10. Several AM detectors are well known in literature such as the Envelope Detector, the Product Detector or heuristics.

Referring to FIGS. 1 and 2, in step 4, Equations (4) and (5) are calculated on the total input frequency analysis. It's assumed that the interfering sources are not mutually distinct and in fact this technology's strength is dealing with the overlap of speech and noise. Functions f₁ and g₁ control the rate of change of the priors through a number of factors including embedded knowledge, variance of the posteriors and previous states.

The key component of step 4 is to update the shape of the speech and noise posteriors in each frequency band. Since the magnitude is used in each band, the distribution could be characterized as roughly Chi-squared, but because speech is not Gaussian this is not strictly correct. The preferred embodiment uses point sampling to build probability mass functions (pmfs), but the posteriors can be described by any histogram building function.

P(Speech|X^{m})=f₂(X^{m},X^{m-},X^{m-2}, . . . ,X^{m-L}) (6)

P(Noise|X^{m})=g₂(X^{m},X^{m-1},X^{m-2}, . . . ,X^{m-L}) (7)

where P is a distribution, and functions f₂ and g₂ make use of the structure of the audio flow. An example of a long average, coarsely sampled P is given in FIG. 4. These functions are parameterized by the priors of speech and noise, which alter their adaptation rates. They both operate differently. f₂ is asymmetrical around a point in the high tail of the speech pdf. It accelerates adaptation to higher levels, accentuating high entropy pieces of data that increase the posterior's kurtosis. g₂ on the other hand adapts strongest to near zero excess kurtosis. Thus data coming in is smoothed, or attenuated in the amplitude modulation domain if it fits the noise hypothesis, or will be accentuated if it fits the speech pmf. There are significant differences on how functions f₂ and g₂ operate depending on the choice of representations for the posteriors. f₂ and g₂ control how much adaptation is done but it's done to all models with the totality of input data with f₂ being a big update if the data matches well and g₂ being very small if the posterior doesn't match very well. Also f₂ and g₂ have memory involved, ie. When we're in a class then we're probably going to stay in that class so updates should be stronger. Equations (4) and (6) are fundamental to the operation of Bayes rule, described by:

$$P ( A \vert B ) = \frac{P ( B \vert A ) P ( A )}{P ( B )} \qquad ( A )$$

In short the system observes what the frequency analysis should be given that we're in one of our classes. Similarly Equations (5) and (7) are another application of Bayes rule.

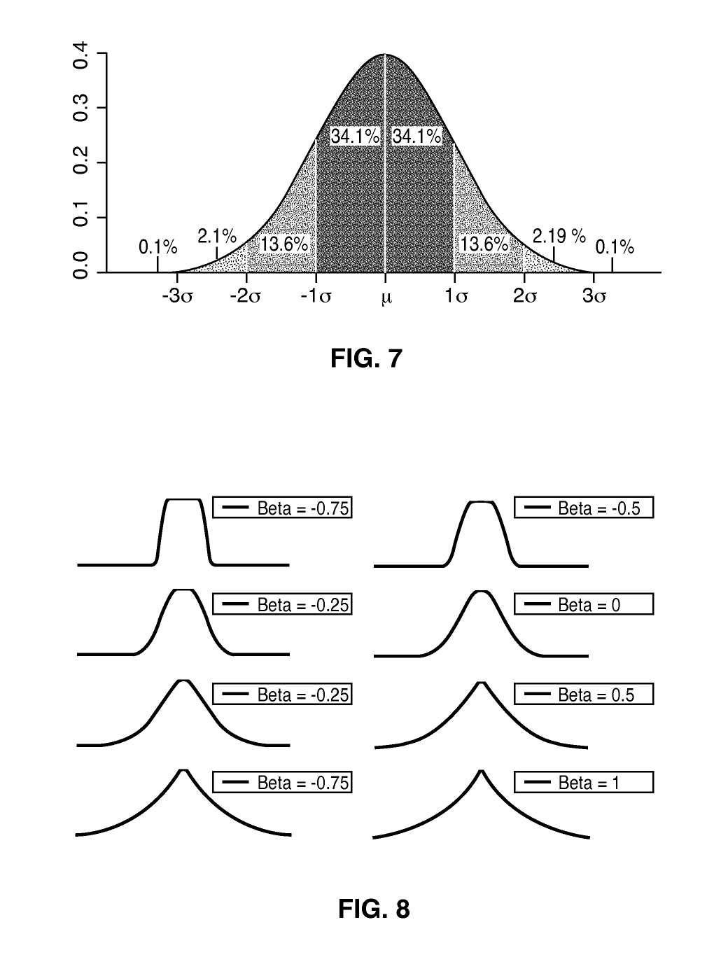

Minimally, the mean, variance, and a higher order descriptive statistic can be used for the posteriors (for example the exponent power if fitting to the generalized Gaussian family of curves). For a basic implementation a minimum of three points will be taken. Using the Gaussian (see FIG. 7) for simplicity it can be shown that keeping track of the percentile limits for 50%, 84.3% and 97.9% can simplify future calculations.

Labelling these points a, b and c, respectively one has a proxy for the entropy of the distribution. For a Normal distribution (b−a)/(c−b)=1. That is the 84.3% point and is always one standard deviation from the mean. The 97.9% point is always one standard deviation from the mean plus one standard deviation. It can be seen for pmfs that are not Gaussian the result of (b−a)/(c−b) will be greater than one when the distribution is super-Gaussian, or has an excess kurtosis greater than zero, and the result will be less than one when the distribution is sub-Gaussian, or has an excess kurtosis less than zero. This is useful in future steps to assess the posterior distributions of speech and noise, information content. Loosely, maximizing this kurtosis proxy for the speech posterior through the nonlinear gain function will produce an output with a taller and narrower distribution, resulting in a “peakier” or a “speechier” output. Minimizing the kurtosis proxy for the noise posterior through the nonlinear gain function will attenuate distortions.

This three point technique can be extended to any number of N by standard histogram building techniques. The basic use remains the same: maximize the peaks for speech (or decrease the entropy) through the system, and minimize peaks for noise (or increase the entropy). If processing and memory constraints on the target processor allow for N greater than three in the histogram a better posterior can be made. As N becomes large and processor constraints become more liberal the information quantity can be calculated directly using the standard definition of entropy or any of the offshoots. In standard DSP processors the log function is still expensive, and often implemented by using a look up table, introducing a lot of error. So a practical implementation with a large number of pmf bins can have the posterior described by fitting to the family of generalized Gaussians. The family of generalized Gaussians are described by:

$$p ( s \vert μ , σ , β ) = \frac{1}{σΓ ( 1 + \frac{1 + β}{2} ) {2}^{1 + \frac{1 + β}{2}}} exp ( \frac{1}{2} {\vert \frac{s - μ}{σ} \vert}^{\frac{2}{1 + β}} ) \qquad ( 8 )$$

where μ is the mean, σ the standard deviation and the β parameter describes the shape. The family of curves is shown in FIG. 8 for certain values of β.

β can then be seen to directly impact the higher order moments, and information content. Hence β can be used as a proxy of information. The higher the β, the lower the entropy, with β=0 being the Gaussian, optimal infinite range distribution, and β>0.75 being an approximation of speech. The mean and standard deviation can be calculated directly, inexpensively, from the data, X^{m} coming in. β can then be solved for by curve fitting, using a numerical analysis tool such as Newton-Raphson or Secant search. β is then a measure of how “speech” something is and what operation must be done to ensure it is speechy. In FIG. 8 β approaching positive 1 are required for the speech posterior. Thus a ζ function that increase the output β is desired. While the ζ function also aims to force the output posterior to have a β of 0.

Step 5 uses the flow from surrounding blocks of data and across frequencies (relationship implicit), to calculate a linear or parabolic trajectory that bests fits the present data X^{m}. This effectively smoothes the maximum likelihood case; reducing fast fluctuations from noise. In a non-limiting example this update is always backwards looking, that is to say, without latency. The addition of latency enables another possibility such that:

P(Speech|X^{m})=f₂(X^{m+B}, . . . ,X^{m},X^{m-1},X^{m-2}, . . . ,X^{m-L}) (9)

In the most basic form the posteriors are calculated by:

P(X^{↑}m|Speech)=(P(Speech┤|X^{↑}m)P_{↓}(X^{↑}m))/P_{↓}Speech (10)

P(X^{↑}m|Noise)=(P(Noise┤|X^{↑}m)P_{↓}(X^{↑}m))/P_{↓}Noise (11)

Equation (10) and (11) are separate, straight applications of the Bayes rule (see (A)). It is plain that these values can be used in a similar way to the Speech and Noise power estimates used in the standard Wiener filter noise reduction framework. That is, instead of the typical implementation where the gain, W, of a particular frequency band, k, is given by the ratio of the speech power, S, over the speech plus noise power, N:

$${W}_{k} = \frac{\vert {S}_{k} \vert}{\vert {S}_{k} \vert + \vert {N}_{k} \vert} \qquad ( 12 )$$

Equation (12) states in frequencies where the signal power is much larger than the noise power have the gain approach one, ie. leave it alone. At frequencies where the noise estimate is much larger than the speech estimate the denominator will dominate and the gain will approach zero. In between these extremes the Wiener filter loosely approximates attenuating based on the signal to noise ratio. The simplest probabilistic denoising has a similar framework. We replace the power estimates with the posteriors calculated from Equations 10 and 11, and the simple transformation that was [0, 1] with a function the A ensures that the division is defined. A simple implementation for step 6 may be

W_{g}^{k}=ζ(P(X^{↑}m|Speech)/(P(X^{↑}m|Noise)+Δ)) (13)

If ζ must be a non-linear function this will maximize when the present input data is very similar to speech, and attenuates when the probability of noise is high. In the Wiener filter each frequency gain is a strictly linear operation, thus independently a frequency band does not change the shape of the output distribution, only scales it. The overall SNR is altered, but not the inband SNR. ζ meanwhile functionally changes with the input probabilities. FIG. 5 is an example illustrative of an operation similar to the base Wiener filter. An example improved embodiment is given in FIG. 9 where the probability of unvoiced speech is very high. This operator has a defined temporal envelope, and is designed for plosives, fricatives, or components whose information is encoded in time. Step 7 applies the weights from each band to the input data and step 8 is the frequency synthesis of the inverse of step 2.

The discussion that follows, explains how the design of f₂, g₂ and ζ, differs further from Wiener Filter based noise reduction. The Wiener Filter is optimal in the least square sense, but there is an implicit assumption on steady state statistics. The present invention is built to be very effective with non-stationary noises. For this improved functioning, f₂ and g₂ are nonlinear with respect to the calculated information content in the posterior at step m−1.

P(Speech|X^{m})=(1−f₂)P(Speech|X^{m-1})+f₂N(X^{m},σ²) (B)

The above (B) details one example of the update and how f₂ maximizes with low entropy, while the inverse is true for g₂. In this way the speech posterior will learn to be a “peakier” distribution, while the noise posterior will learn to be near Gaussian. The most obvious implementation of f₂ is when new data comes in that would make the speech posterior have lower entropy, the update to that posterior should be more trusted. In (B), f₂ is a function of output entropy; f₂ would approach 1 if output entropy is minimized for the posterior, or 0 if the posterior become less speech. In the preferred embodiment a proxy of higher order statistics is used to drive the adaptation shape. Other implementations can include heuristics, calculation of kurtosis or fitting to the generalized Gaussian and tracking the β parameter.

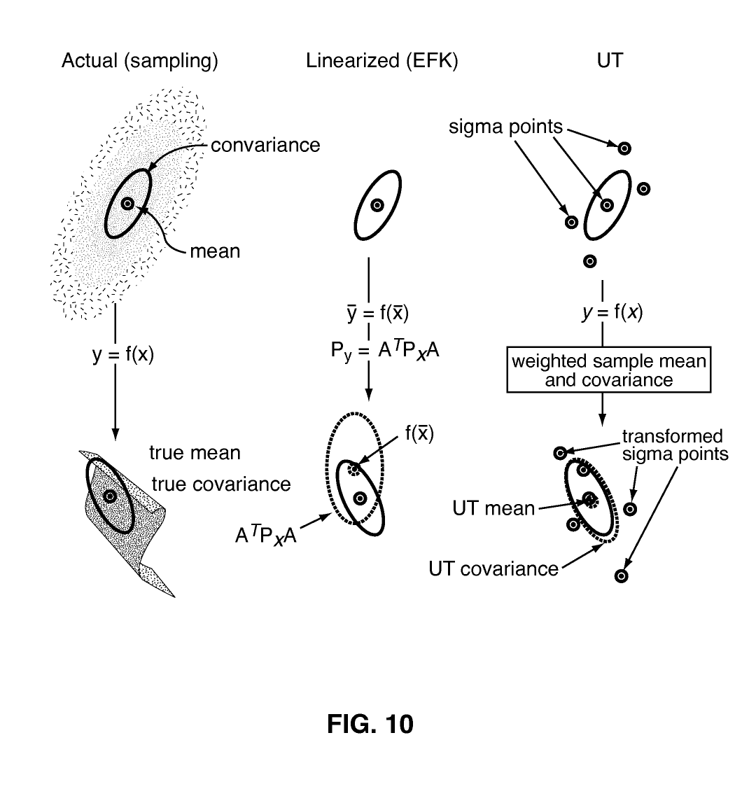

f₂ and g₂ also influence the shape of ζ. The nonlinearity minimizes the classical definition of entropy (or any information proxy) for the speech distribution (makes it peakier) while maximizing the classical definition of entropy for noise distributions (reducing transients). This can be explained using the thought behind the unscented Kalman filter (UKF). In the UKF one has a Gaussian distribution, x, transformed through a nonlinearity f to produce a distribution y (see left of FIG. 10). The extended Kalman filter (EKF) this process is modeled quite poorly (see center of FIG. 10), while moving the points through UKF uses the known nonlinearity to move a point sampling process to the new manifold, resulting in excellent estimation of the true distribution. This two dimensional picture is representative of a complex data transformation and it can be extended to multivariate distributions as well as the degenerate case of a real value distribution.

In the noise reduction case ζ maps the noisy x into a y that resembles clean speech, instead of the estimation problem. Along with the simplistic mapping to the Wiener filter equivalent stated above another implementation uses a mixture of histogram equalization based on calculating the cumulative distribution function (cdf) of the noise posterior with the inverse function of the cdf for the speech posterior. Since it is an inverse, there must be some sort of regularization, such as the simple implementation's Δ parameter to bound the solution. A scaling to maximum unity gain is a preferred embodiment. The mixture ratio is controlled by f₁ and g₁. For example if there is only babble noise, histogram equalization will move that posterior with excess kurtosis to one approaching zero kurtosis, resulting in decreased RMS. Conversely speech will have its RMS increased through the inverse of histogram equalization. An alternate implementation regularizes the power of output speech to equal the input power. This results in the same Signal to Noise ratio, but will attenuate the overall noise power.

In summary, the problem of reducing the resultant noise in a noise-corrupted system is sufficiently alleviated by the noise reduction in the module 10 of FIG. 1, which takes a non-linear approach based on information theory. By making use of the temporal qualities of speech, and tracking and updating these hypotheses over time, the process reduces the high-entropy content that is the unwanted content or noise, while keeping and highlighting the important speech content of the input audio source. This improves the sound quality and ease of listening.

In the above example, the module 10 of FIG. 1 employs WOLA filterbank. However, it is robust to any frequency analysis first step of FIG. 1, such as Short-Time-Fourier-Transform (STFT), Cepstral, Mel-Frequency, subband processing or any transform set to function like a cochlear operation. It reduces the amount of redundant and non-speech information from an input audio source without impacting important speech information. It calculates speech and noise hypotheses and uses, for example, a proxy of Bayesian decision making. The process reduces the information of noise while keeping speech information of the input audio source. This reduces the cognitive load associated with sifting through the audio channel, improving sound quality and ease of listening.

It can reduces perceived noise level for stationary noise 20 dB, and for non-stationary noise 20 dB. Quantitative increase in Mean Opinion Score (MOS). The noise reduction technique according to the embodiment of the present invention can be used to drive improved adaptive (i.e. online) control of other audio signal processing algorithms. WOLA filterbank processing ensures low power. It will be flexible regarding the audio processing. Since there is almost no latency, sub 10 ms, allowing for easy integration in all applications. It is robust to levels due to probabilistic bases, and therefore mic variations.

All references cited herein are incorporated by reference.

What is claimed is:

1. A method for noise reduction comprising the steps:
(1) receiving a noise corrupted signal;
(2) transforming the noise corrupted signal to a time-frequency domain representation;
(3) determining probabilistic bases for operation, the probabilistic bases being priors in a multitude of frequency bands calculated online;
(4) adapting longer term internal states to calculate long term posterior distributions;
(5) calculating present distributions that fit data;
(6) generating non-linear filters that minimize entropy of speech and maximize entropy of noise, thereby reducing the impact of noise while enhancing speech;
(7) applying the filters to create a primary output in a frequency domain; and
(8) transforming the primary output to the time domain and outputting a noise suppressed signal.

2. The method of claim 1 where the step of transforming to a time-frequency domain representation comprises:
implementing the time-frequency domain representation by Weighted-Overlap-And-Add (WOLA) function, Short-Time-Fourier-Transforms (STFT), cochlear transforms, or wavelets

3. The method of claim 1 where the step of determining probabilistic bases comprises:
updating of speech and noise posteriors through, at least one of:
a soft decision probability of fitting the previously calculated posteriors function;
Voicing Activity Detectors;
classification heuristics;
HMMs;
Bayesian approach.

4. The method of claim 1 wherein the nonlinear filters are derived from higher order statistics.

5. The method of claim 1 wherein the adaptation of internal states is derived from an optimal Bayesian framework.

6. The method of claim 1, comprising implementing:
a soft decision probabilities or hard decision.

7. The method of claim 6, wherein the soft decision probabilities are limited or the hard decision heuristic is used to determine the nonlinear processing based on a proxy of information theory.

8. The method of claim 1 where the probabilistic bases in steps (3), (4) and (5) are formed by point sampling probability mass functions, or a histogram building function, or the mean, variance, and a higher order descriptive statistic to fit to the generalized Gaussian family of curves.

9. The method of claim 1 where the step of generating has an optimization function using a proxy of higher order statistics, or a heuristics, or calculation of kurtosis or fitting to the generalized Gaussian and tracking the β parameter

10. The method of claim 1 further comprising at least one of:
embedded a priori knowledge of noise reduction statistics; and
embedded a priori knowledge of speech enhancement statistics.

11. The method of claim 1 comprising at least one of:
tracking amplitude modulation for the separation of speech from noise.
the addition of psychoacoustic masking in the generation of filters;
implementing spatial filtering before the noise reduction operation.

12. The method of claim 1 wherein probabilistic bases for operation is replaced with heuristics to reduce computational load.

13. The method of claim 12 wherein the distributions are replaced with tracking statistics, minimally identifying mean, variance and at least another statistic identifying higher order shape.

14. The method of claim 12 wherein Bayes optimal adaptation of posteriors are replaced with heuristics for adaptation.

15. The method of claim 12 wherein heuristically driven device is used for the operation.

16. A machine readable medium having embodied thereon a program, the program providing instructions for execution in a computer for a method for noise reduction, the method comprising:
receiving acoustic signals;
determining probabilistic bases for operation, the probabilistic bases being priors across multiple frequency bands calculated online;
generating nonlinear filters that work in an information theoretic sense to reduce noise and enhance speech;
applying the filters to create a primary acoustic output; and
outputting a noise suppressed signal.

17. A method of claim 1, wherein the step (4) comprises at least one of generating:
P_{speech}[m+1]=f₁(P_{speech}[m],X^{m+1})
Pₙₒᵢₛₑ[m+1]=g₁(P_{speech}[m],X^{m+1})
where P is a prior distribution based on the log magnitudes of the frequency domain data, and f₁ and g₁ are update functions that quantify the new data's relationship to the previous data and update the overall probabilities, or.
updating the shape of speech and noise posteriors in each frequency band.

18. A method of claim 17, wherein the update is implemented by:
P(Speech|X^{m})=f₂(X^{m},X^{m-1},X^{m-2}, . . . ,X^{m-L})
P(Noise|X^{m})=g₂(X^{m},X^{m-1},X^{m-2}, . . . ,X^{m-L})
where P is a distribution and functions f₂ and g₂ make use of the structure of the audio flow, and the functions are parameterized by the priors of speech and noise, which alter their adaptation rates.

19. A method of claim 18, comprising:
minimizing kurtosis proxy for the noise posterior

20. A method of claim 1, wherein the posteriors are calculated:
P(X^{↑}m|Speech)=(P(Speech┤|X^{↑}m)P_{↓}(X^{↑}m))/P_{↓}Speech
P(X^{↑}m|Noise)=(P(Noise┤|X^{↑}m)P^{↑}m)P_{↓}(X^{↑}m))/P_{↓}Noise

21. A method of claim 1, wherein the step (6) us implemented by:
W_{g}k=ζ(P(X^{↑}m|Speech)/(P(X^{↑}m|Noise)+Δ))

22. A system for noise reduction on audio signals, comprising:
a transformer for transforming a noise corrupted signal to a time-frequency domain representation;
a module for determining probabilistic bases for operation, the probabilistic bases being priors in a multitude of frequency bands calculated online;
a module for adapting longer term internal states to calculate long term posterior distributions;
a calculator for calculating present distributions that fit data;
a generator for generating non-linear filters that minimize entropy of speech and maximize entropy of noise, thereby reducing the impact of noise while enhancing speech, the filters being applied to create a primary output in a frequency domain; and
a transformer for transforming the primary output to the time domain and outputting a noise suppressed signal.
